(19) United States
(12) Patent Application Publication
(10) Pub. No.: US 2013/0346985 A1
(43) Pub. Date: Dec. 26, 2013

(54) MANAGING USE OF A FIELD PROGRAMMABLE GATE ARRAY BY MULTIPLE PROCESSES IN AN OPERATING SYSTEM

(71) Applicant: Edmund B. Nightingale, Redmond, WA (US)

(72) Inventor: Edmund B. Nightingale, Redmond, WA (US)

(73) Assignee: MICROSOFT CORPORATION, Redmond, WA (US)

(21) Appl. No.: 13/528,175

(22) Filed: Jun. 20, 2012

(51) Int. Cl. G06F 9/46

(52) U.S. Cl. 718/102

(57) ABSTRACT

Field programmable gate arrays can be used as a shared programmable co-processor resource in a general purpose computing system. An FPGA can be programmed to perform functions, which in turn can be associated with one or more processes. With multiple processes, the FPGA can be shared, and a process is assigned to at least one portion of the FPGA during a time slot in which to access the FPGA. Programs written in a hardware description language for programming the FPGA are made available as a hardware library. The operating system manages allocating the FPGA resources to processes, programming the FPGA in accordance with the functions to be performed by the processes using the FPGA, and scheduling use of the FPGA by these processes.

### BACKGROUND

In most general purpose computers, an operating system is the primary software that manages access to resources within the computer. The primary resources are the central processing unit (CPU), which executes application programs designed to run on the computer, main memory and storage. In some computer architectures, additional processing units (such as multiple cores in a processor) and/or additional processors, called co-processors, may be present. Examples of such co-processors include a graphic processing unit (GPU) and a digital signal processor (DSP). The operating system also manages access to these resources by multiple processes.

A field programmable gate array (FPGA) is a kind of logic device that is commonly used in specialized computing devices. An FPGA typically is used to perform a specific, dedicated function, for which a gate array is particularly well-suited. FPGAs typically are found in peripheral devices, or other specialized hardware, such as a printed circuit board connected to and accessed through a system bus such as a PCI bus. In general, such devices are programmed once, and used many times. Because these devices are programmable, they have an advantage over other specialized logic devices in that they can be updated in the field.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

One or more field programmable gate arrays (FPGA) can be used as a shared programmable co-processor resource in a general purpose computing system. An FPGA can be programmed to perform functions, which in turn can be associated with one or more processes. With multiple processes, the FPGA can be shared, and a process is assigned to at least one portion of the FPGA during a time slot in which to access the FPGA. Programs written in a hardware description language for programming the FPGA are made available as a hardware library. The operating system manages allocating the FPGA resources to processes, programming the FPGA in accordance with the functions to be performed by the processes using the FPGA, and scheduling use of the FPGA by these processes.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computing system with FPGA resources for which an operating system can be implemented.

FIG. 2 is a schematic diagram of an illustrative example of FPGA functional units.

FIG. 3 is a schematic diagram of an example architecture of an application using hardware and software libraries on a computer system with FPGA resources.

FIG. 4 is a diagram illustrating the use of FPGA resources over time.

FIG. 5 is a diagram of a data structure for storing data associating an FPGA functional unit with a process

FIG. 6 is a flow chart of an example implementation of associating an FPGA functional unit with a process.

FIG. 7 is a flow chart of an example implementation of analyzing code to identify code blocks that can be accelerated by an FPGA library.

### DETAILED DESCRIPTION

The following section provides a brief, general description of an example computing environment in which an operating system for managing use of FPGA resources can be implemented. The system can be implemented with numerous general purpose or special purpose computing devices. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

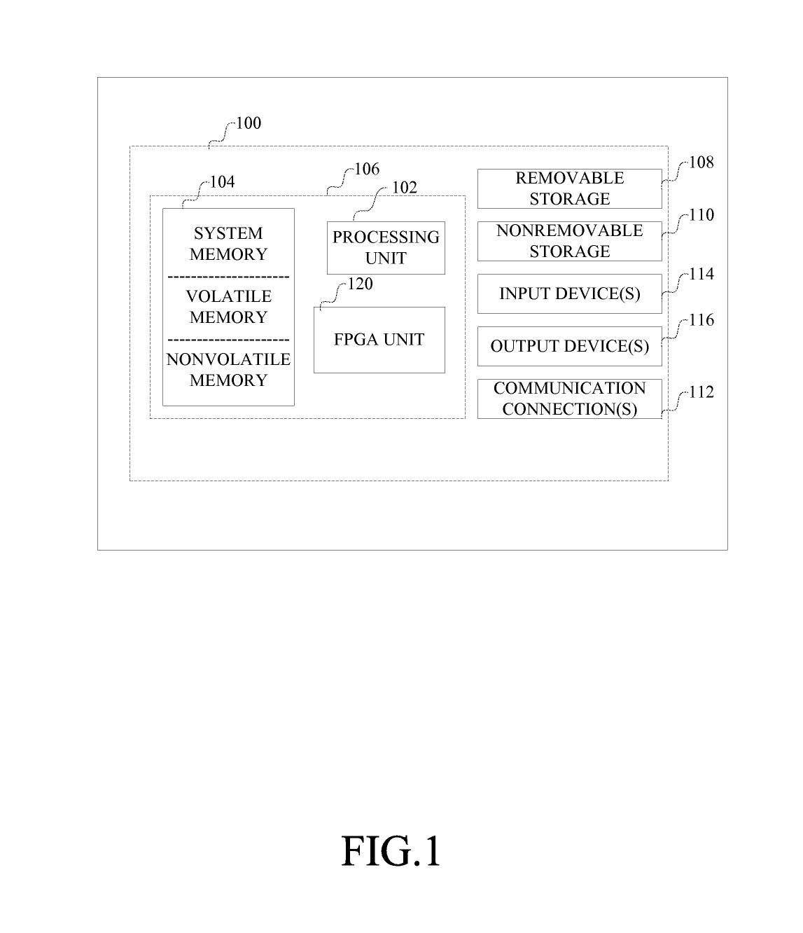

FIG. 1 illustrates merely an example computing environment, and is not intended to suggest any limitation as to the scope of use or functionality of a suitable computing environment.

With reference to FIG. 1, an example computing environment includes a computing device 100. In a basic configuration, computing device 100 includes at least one processing unit 102, such as a typical central processing unit (CPU) of a general purpose computer, and memory 104.

The computing device may include multiple processing units and/or additional co-processing units such as a graphics processing unit (GPU). The computing device also includes one or more field programmable gate arrays (FPGA), denoted as FPGA unit 120 which is available as a shared (among processes running on the computer) co-processing resource. An FPGA may reside in its own CPU socket or on a separate card plugged into an expansion slot, such as a Peripheral Component Interconnect Express (PCI-E) slot. By providing such an FPGA unit, a variety of functions that are well-suited for implementation by a gate array can be implemented with the resulting benefit of hardware acceleration.

Depending on the configuration of the processing unit and the FPGA unit, the unit, or each functional unit within it, has an associated input/output channel for communication with host operating system processes. For example, a memory region dedicated to the functional unit and shared between it and a process using that functional unit can be provided. A sort of request queue and response queue also can be used to enable asynchronous invocation of operations implemented in the FPGA unit. Additionally, state of the functional units in the FPGA unit for a process can be saved to and restored from a memory region for the functional unit and that process. Alternatively other techniques can be used to ensure that the functional unit is in a known state before it is used by its process.

Depending on the configuration and type of computing device, memory 104 may be volatile (such as RAM), non-volatile (such as ROM, flash memory, etc.) or some combination of the two. This configuration of a processing unit, co-processor and memory is illustrated in FIG. 1 by dashed line 106.

Computing device 100 may also have additional resources and devices. For example, computing device 100 may include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer program instructions, data files, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 also can include communications connection(s) 112 that allow the device to communicate with other devices over a communication medium. The implementation of the communications connection 112 is dependent on the kind of communication medium being accessed by the computing device, as it provides an interface to such a medium to permit transmission and/or reception of data over the communication medium. A communication medium typically carries computer program instructions, data files, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing device 100 may have various input device(s) 114 such as a keyboard, mouse, pen, camera, touch input device, and so on. Output device(s) 116 such as a display, speakers, a printer, and so on may also be included. All of these devices are well known in the art and need not be discussed at length here.

Applications executed on a computing device are implemented using computer-executable instructions and/or computer-interpreted instructions, such as program modules, that are processed by the computing device. Generally, program modules include routines, programs, objects, components, data structures, and so on, that, when processed by a processing unit, instruct the processing unit to perform particular tasks or implement particular abstract data types. In a distributed computing environment, such tasks can be performed by remote processing devices that are linked through a communications network. In a distributed computing environment, program modules may be located in both local and remote computer storage media including memory storage devices.

An operating system executed on a computing device manages access to the various resources of the computer device by processes. Typically, running an application on the computer system causes one or more processes to be created, with each process being allocated to different resources over time. If a resource is shared among processes, and if the processes cannot share the resource concurrently, then the operating system schedules access to the resource over time. One of such resources is the FPGA unit 120 of FIG. 1, which can include one or more discrete FPGA's.

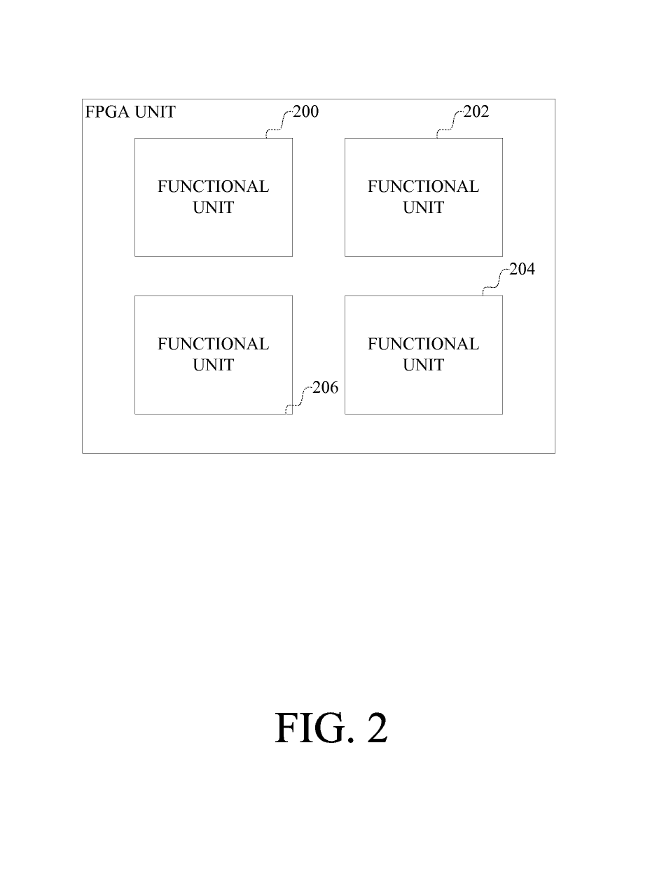

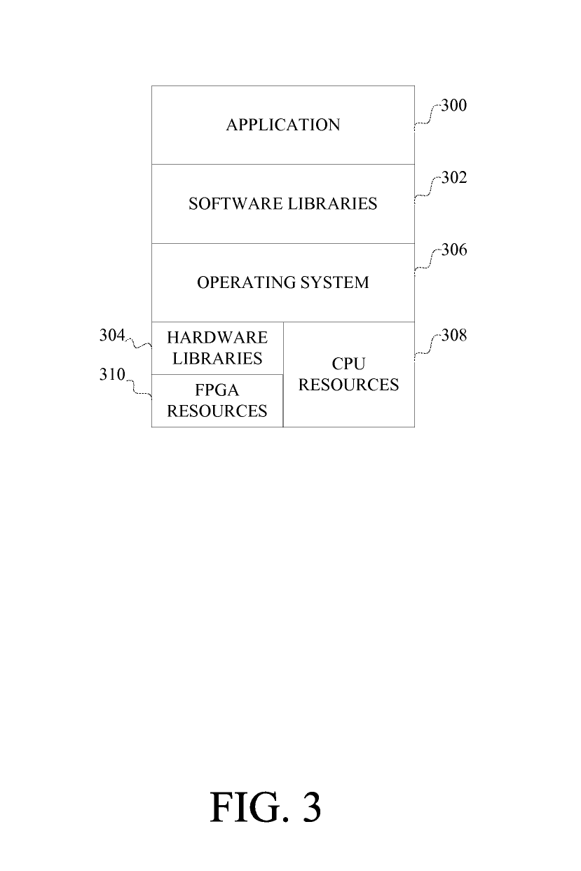

Referring to FIG. 2, one of the resources within the FPGA unit is one or more groups of programmable gates, herein called functional units. Each functional unit is defined by a set of gates and/or other resources in the gate array. In general, functional units are nonoverlapping, i.e., do not share programmable elements within the gate array. For example, as illustrated schematically in FIG. 2, functional units 200, 202, 204 and 206 are non-overlapping. Most FPGAs have only one functional unit. The FPGA unit 120 in FIG. 1, however, can have one or more FPGAs. With multiple FPGAs, each FPGA can be considered a functional unit. Referring to FIG. 3, each functional unit is a resource that can be assigned to one or more processes, programmed by the operating system using a hardware library that implements an operation, and then used by the processes assigned to it to perform the operation. Referring to FIG. 3 as an example, an application 300 can use conventional software libraries 302, and FPGA hardware libraries 304, to perform various operations. If an application relies on a hardware library 304, then the operating system 306 uses the hardware library to program the FPGA resources 310 to allow the application 300 to use the library. The FPGA can be programmed prior to the application beginning execution. If an FPGA can be reprogrammed quickly enough, the library can be loaded into the FPGA in a scheduling quantum of the operating system. The operating system 306 also executes software commands from the application 300 and software libraries 302 on the CPU 308. When the application makes calls to functions performed by a software library, the operating system executes the function from the software library on the CPU 308. When the application makes calls to functions performed by the FPGA, the operating system ensures that the FPGA is programmed using the hardware library and executes the function using the FPGA.

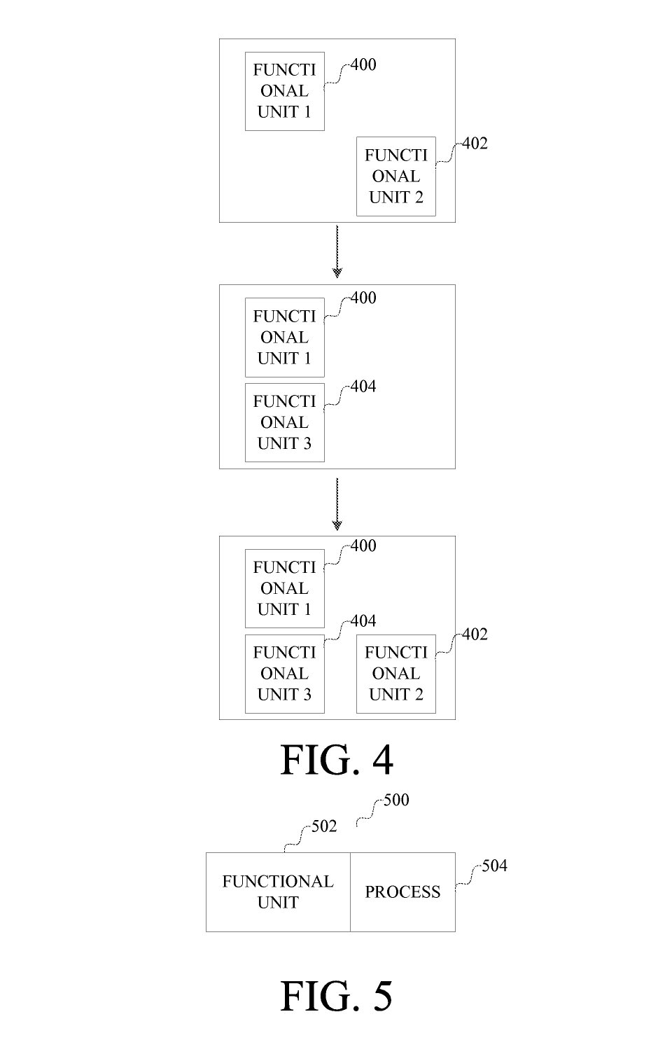

To illustrate how different functional units can be used over time, reference is now made to FIG. 4. In FIG. 4, at time T1, functional units 400 and 402 are being used. At time T2, functional units 400 and 404 are being used. At time T3, functional units 400 and 402 are again being used. At time T1, functional unit 400 can be assigned to process P1, and functional unit 402 can be assigned to process P2. At time T2, process P2 may be inactive, and process P1 can use functional unit 400 and process P3 can use functional unit 404. At time T3, another process can start using functional unit 400, such as process P4; and process P2 can be active again at use functional unit 402. With current FPGA implementations, the use of multiple functional units at the same time by different processes implies the use of multiple FPGAs. To the extent that an FPGA can support multiple functional units being used by different processes at the same time, these functional units can be on the same FPGA. Effectively, the operating system is statistically multiplexing the FPGA in both time and space.

To allow such usage of the FPGA resources by different processes over time, the operating system has a scheduler that determines which process has access to the FPGA resources at each scheduling quantum, i.e., time period, and when an FPGA functional unit will be programmed with a hardware library so that the functional unit is available to be used by that process. Thus, an implementation of a scheduler for the FPGA unit is dependent in part on the nature of the FPGA unit and the one or more FPGAs it includes. Factors related to the FPGAs to be considered include, but are not limited to, the following. For example, in some cases an entire FPGA is refreshed to program a functional unit if one functional unit cannot be programmed independently of other functional units. Another consideration is the speed with which a functional unit can be programmed, and whether programming of a functional unit prevents other functional units from being used during that programming phase. Another factor to consider is whether processes can share a hardware library by sharing a functional unit. The scheduler also takes into account such factors as the number of concurrent processes, application performance guarantees, priority of applications, process context switching costs, access to memory and buses, and availability of software libraries if no functional unit is available within the FPGA unit.

There may be other instances where the FPGA unit provides a general purpose facility to applications or the operating system, which therefore are scheduled for the length of an application instantiation. For example, custom network protocols or offloading can be offered as an accelerated service on the FPGA unit. System calls or standard library calls, normally executed in a general purpose CPU, can be accelerated using the FPGA unit instead. Further, the operating system can multiplex the CPU based on preferences for process priority. In another instance, the operating system can use a profile of an application, generated statically or dynamically, to predict the functionality best suited for running on an FPGA unit and then pre-load that functionality so that it is available for scheduling. By using the profile as a guide, the operating system can ensure there is both space and time available on the FPGA unit to accelerate the application. Finally, the operating system can use simple hints from the application to know when to schedule time on the FPGA unit. For example, certain calls into the operating system (system calls) can denote long delays (calls to disk or the network), which provides a hint that the FPGA unit can be free for some amount of time for other threads or processes to use. Therefore, the operating system uses a variety of hints and preferences to create a schedule to multiplex access to the FPGA unit. Because the operating system controls the scheduler, it has detailed knowledge of executing and pending work, available hardware libraries, and time it takes to program an FPGA. Therefore, it can use this knowledge to determine which processes leverage the FPGA during execution.

Having now described a general overview of such computer architecture, an example implementation will now be described.

Referring to FIG. 5, to maintain a relationship between functional units of the FPGA unit and processes, the operating system stores a data structure 500 that associates each functional unit to the process or processes using it. Multiple processes can share the same functional unit, but use the functional unit during different scheduling quanta. This data structure can take a variety of forms, and can include information about the functional units 502 and processes 504 to aid in associating functional units with processes. An application can be associated with one or more functional units at compile time, installation time, and/or run time. The association between a functional unit and a process running an application can be made at installation time or runtime. The association can be static or dynamic.

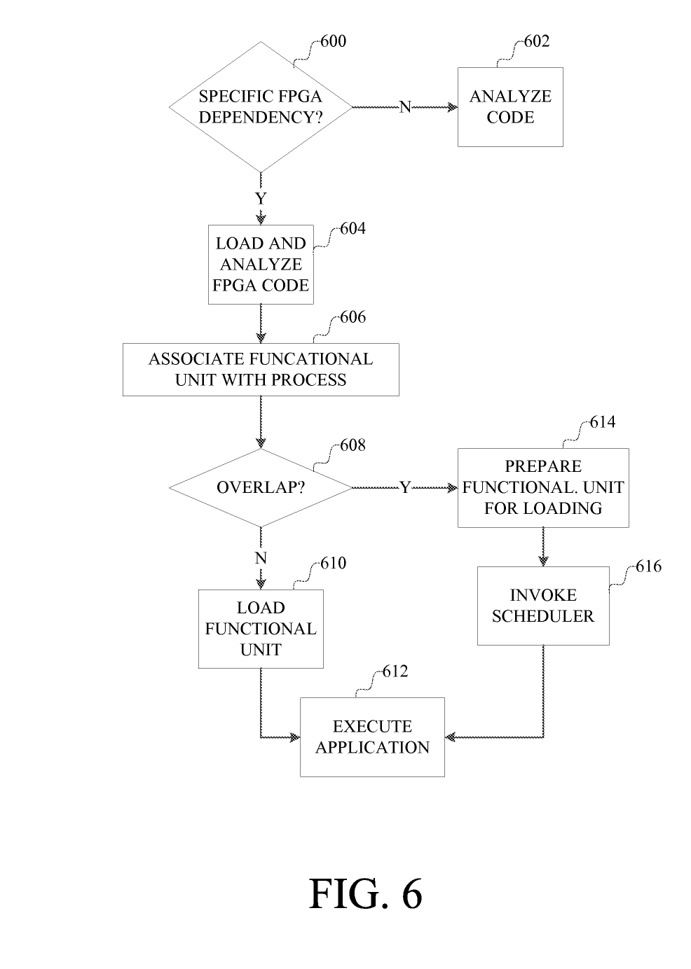

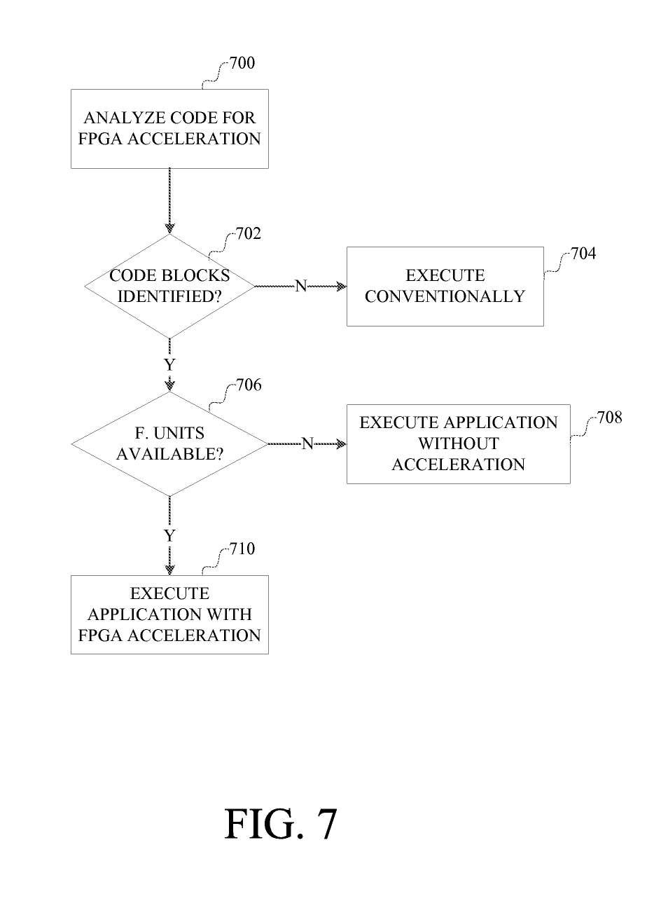

An example of associating a functional unit with a process at runtime will now be described in connection with FIG. 6. When an application is executed, the operating system determines (600) whether the application has a dependency to a specific FPGA library. If not, then its code can be analyzed (602, and see FIG. 7) below to determine whether an FPGA library can be available for use. If there is a specific dependency, the FPGA library is loaded and analyzed 604 to define the functional unit of the FPGA unit that is used. This functional unit is associated 606 with the process executing the application. It is then determined 608 if the functional unit is being shared with other processes. If not, the FPGA library can be scheduled for loading 610 into this functional unit, after which the application can execute 612. If there is conflict with other processes sharing this functional unit, then the FPGA library can be queued 614 for loading into the FPGA. A scheduler within the operating system is then invoked 616 to determine when the FPGA library can be loaded to program the functional unit, and subsequently when the application can be executed 612.

As noted above, after a process for executing an application is associated with a functional unit, the operating system scheduler schedules programming the functional unit with a hardware library.

When programming the FPGA, a scheduler can consider whether other processes are using the FPGA, and whether programming the FPGA involves pausing those other processes (after their use of the FPGA has completed). As an example, the scheduler can wait until a process has become dormant, or has not been using the FPGA, to initiate programming the FPGA. If the FPGA is in the course of being programmed when another process become active, that other process can be paused until the FPGA programming has completed.

The scheduler also can consider how long it takes to program the FPGA, and whether programming the FPGA will result in a functional unit being programmed differently for different processes over time. As an example, the scheduler can detect that two processes are using a same functional unit but with different hardware libraries. In such a case, the scheduler can signal an exception, in response to which one of the processes uses a software library instead of a hardware library. The scheduler can also consider whether the FPGA can be reprogrammed quickly enough within a scheduling quantum, and how frequently the FPGA is accessed by each process, in determining whether to signal an exception. Such detection also can occur during loading of a process instead of in the scheduler.

In some cases, as noted above in connection with 602 in FIG. 6, an application does not have an explicit dependency on an FPGA library. For example, the application may include calls to an API to implement various functions. This API, however, can be implemented on the computer system as a software library, or an FGPA library, or other library (e.g., code for a graphical processing unit (GPU)), etc. The code of the application can be scanned to identify references to an API that has references to an FPGA library.

For an example implementation, as noted in FIG. 7, the code is analyzed 700 to identify blocks of code that can be implemented using an FPGA library. If no code blocks are identified 702, then the application is executed 704 in a conventional manner without using FPGA libraries. If code blocks are identified, it is then determined (706) if functional units are available to support the identified FPGA library. If insufficient FPGA resources are available, then the application can be executed 708 in a conventional manner without using FPGA libraries. Otherwise, the application is executed 710 with the identified FPGA libraries, which are loaded and analyzed in accordance with the process of FIG. 6.

After a process for executing an application is associated with a functional unit, and the functional unit is programmed with a hardware library, the operating system scheduler schedules access to the FPGA unit by different processes.

As an example, if two or more applications share the same hardware library, then access to an FPGA functional unit implementing that library can be multiplexed over time between the two processes. The sharing of the FPGA resource can be implemented in a manner similar to processes sharing other resources in the operating system.

As an example, low-priority processes can be allowed to stall while high-priority processes maximize use of the FPGA. If, notwithstanding the use of different functional units by different processes, only one process can access the FPGA at a time, then access to the FPGA is scheduled in a manner similar to access to other resources by multiple processes. If a computer has too many concurrent processes, some processes can use software implementations instead of functionality provided by the FPGA unit. Having now described an example implementation of such a system, it should be apparent that a variety of data structures can be used to associate FPGA functional units with processes in an operating system. Further, due to the variety of implementations of FPGAs, the operating system implementation for loading and reprogramming the FPGA will vary, depending on the FPGA used. The scheduler implementation also is dependent on the overhead associated with switching between processes using conflicting FPGA resources, which is FPGA-dependent.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computing machine comprising:
a central processing unit and a memory connected to a bus;
a field programmable gate array connected to the bus;
wherein the central processing unit executes application programs, and an operating system that manages usage by application programs of the central processing unit, the memory and the field programmable gate array.

2. The computing machine of claim 1, wherein the field programmable gate array comprises a plurality of functional units.

3. The computing machine of claim 2, wherein each functional unit is separately programmable.

4. The computing machine of claim 2, wherein the operating system associates an application program with a functional unit of the field programmable gate array for a period of time.

5. The computing machine of claim 4, wherein the operating system, before executing an application program, identifies dependencies to hardware libraries for programming the field programmable gate array, and loads the hardware libraries into the field programmable gate array for access by the application program.

6. The computing machine of claim 4, wherein the operating system, before executing an application program, identifies libraries used by the application program, and, if one of the libraries has a hardware implementation, loads a hardware library into the field programmable gate array for access by the application program.

7. The computing machine of claim 4, wherein the operating system multiplexes access to the field programmable gate array by the application programs over time.

8. The computing machine of claim 7, wherein the operating system pauses a process using the field programmable gate array to allow for programming of the field programmable gate array.

9. The computing machine of claim 7, wherein a process with low priority is paused when accessing the field programmable gate array if another process with higher priority is using the field programmable gate array.

10. A scheduling process for an operating system of a computer, comprising:
associating processes with functional units of a field programmable gate array;
determining, at a scheduling quantum, if a process will be active and if the process uses a functional unit of the field programmable gate array;
providing the process access to the functional unit of the field programmable gate array during the scheduling quantum.

11. The scheduling process of claim 10, wherein the FPGA is reprogrammed for the scheduling quantum using a hardware library used by the process that is active for the scheduling quantum.

12. A computer implemented process for managing usage of a central processing unit and a field programmable gate array unit, comprising one or more functional units, in a computer system by application programs, comprising:
associating processes with functional units of the field programmable gate array unit;
identifying hardware libraries for programming the functional units of the field programmable gate array unit; and
ensuring that a functional unit is programmed by a hardware library prior to use of the hardware library by the process.

13. The computer implemented process of claim 12, wherein the field programmable gate array unit comprises a plurality of functional units.

14. The computer implemented process of claim 13, wherein each functional unit is separately programmable.

15. The computer implemented process of claim 13, wherein the operating system associates an application program with a functional unit of the field programmable gate array for a period of time.

16. The computer implemented process of claim 15, wherein the operating system, before executing an application program, identifies dependencies to hardware libraries for programming the field programmable gate array, and loads the hardware libraries into the field programmable gate array for access by the application program.

17. The computer implemented process of claim 15, wherein the operating system, before executing an application program, identifies libraries used by the application program, and, if one of the libraries has a hardware implementation, loads a hardware library into the field programmable gate array unit for access by the application program.

18. The computer implemented process of claim 17, wherein the operating system uses process priorities to determine when processes can access functional units of the field programmable gate array unit.

19. The computer-implemented process of claim 18, wherein the operating system uses profiling information of processes to determine whether to load a hardware library.

20. The computer-implemented process of claim 17, wherein the operating system creates a time and space schedule for processes to use the functional units of the field programmable gate array unit.
